(19) United States
(12) Patent Application Publication
(10) Pub. No.: US 2025/0330521 A1
(43) Pub. Date: Oct. 23, 2025

(54) Multi-protocol combined IoT networking method

(71) Applicant: U-TEC GROUP INC., Union City, CA (US)

(72) Inventor: Lingling QIAN, Union City, CA (US)

(73) Assignee: U-TEC GROUP INC., Union City, CA (US)

(21) Appl. No.: 18/643,829

(22) Filed: Apr. 23, 2024

(51) Int. Cl. H04L 67/125; H04L 69/18

(52) U.S. Cl. CPC H04L 67/125; H04L 69/18

(57) ABSTRACT

The present invention relates to the field of Internet of Things (IOT) technology, specifically a multi-protocol combined loT networking method. The present invention forms an loT system through multiple protocols to realize various connection methods between different devices, which facilitates flexible control of various smart light devices in lighting modules for users, avoids complexities of pure physical switch control and offers a more user-friendly experience, thus meeting diverse customer needs.

### TECHNICAL FIELD

The present invention relates to the field of Internet of Things (IoT) technology, specifically a multi-protocol combined IoT networking method.

### BACKGROUND TECHNOLOGY

Internet of Things (IoT) refers to the interconnection of any object with the network through designated protocols using information sensing devices. Objects exchange information and communicate via information dissemination media to achieve functions such as intelligent identification, positioning, tracking, and supervision.

Existing household lighting fixtures are usually controlled manually and cannot be adjusted for various scenes or brightness levels. Currently, achieving color control and scene adjustments requires adding wiring and physical switches, which not only increases the complexity of manual operation, but is also not user-friendly enough; and in fact, people's experience is compromised in use.

Based on the above reasons, the present invention has designed a multi-protocol combined IoT networking method, which is controlled through a mobile app, enables smart lights to be communicated with each other through an ESP-NOW broadcast mode, achieves one smart light to control others and realizes intelligent control and interconnection functionality.

### SUMMARY OF THE INVENTION

The present invention aims to overcoming shortcomings in the prior art and has designed a multi-protocol combined IoT networking method, which is controlled through a mobile app, enables smart lights to be communicated with each other through an ESP-NOW broadcast mode, achieves one smart light to control others and realizes intelligent control and interconnection functionality.

Therefore, the present invention provides a multi-protocol combined IoT networking method, comprising a lighting module, an MCU control module, and a server module, wherein the lighting module comprises various smart light devices, the MCU control module is used to achieve integration of multiple protocols for IoT networking, and the server module is used to enable communication between a mobile terminal app and the lighting module, as well as to store status information of the lighting module; and the multi-protocol combined IoT networking method further comprises following steps:
S1: a user employs a mobile terminal app to initiate Bluetooth and perform device search within the lighting module through a Wi-Fi Mesh mode;
S2: upon successful discovery, connection with devices is established;
S3: when a single device needs to be controlled, the single device is configured with Wi-Fi and then connected for control;
S4: when multiple devices need to be controlled, multiple devices are searched and connected at a same time in S1, and multiple devices are connected through the Wi-Fi Mesh mode; and
S5: one of the multiple devices transmits data to the server module through a router, and the data information is fed back to the mobile terminal app via Wi-Fi Mesh.

Further, connection with other devices is also able to be established through the ESP-NOW mode after connection with the devices is established.

Further, the devices are able to be connected to each other in a BLE-Mesh mode through voice control by the user.

Compared to the prior art, the present invention forms an IoT system through multiple protocols to realize various connection methods between different devices, which facilitates flexible control of various smart light devices in lighting modules for users, avoids complexities of pure physical switch control and offers a more user-friendly experience, thus meeting diverse customer needs.

### BRIEF DESCRIPTION OF THE DRAWINGS

FIG. 1 is a schematic diagram of an overall framework of the present invention.

FIG. 2 is a schematic diagram showing connection of a single device of the present invention.

FIG. 3 is a schematic diagram of networking through a Wi-Fi Mesh mode of the present invention.

FIG. 4 is a schematic diagram of controlling devices through an ESP-NOW mode of the present invention.

FIG. 5 is a schematic diagram of the present invention controlling devices through BLE-Mesh mode of the present invention.

### SPECIFIC EMBODIMENTS

The present invention is further described in conjunction with the attached drawings.

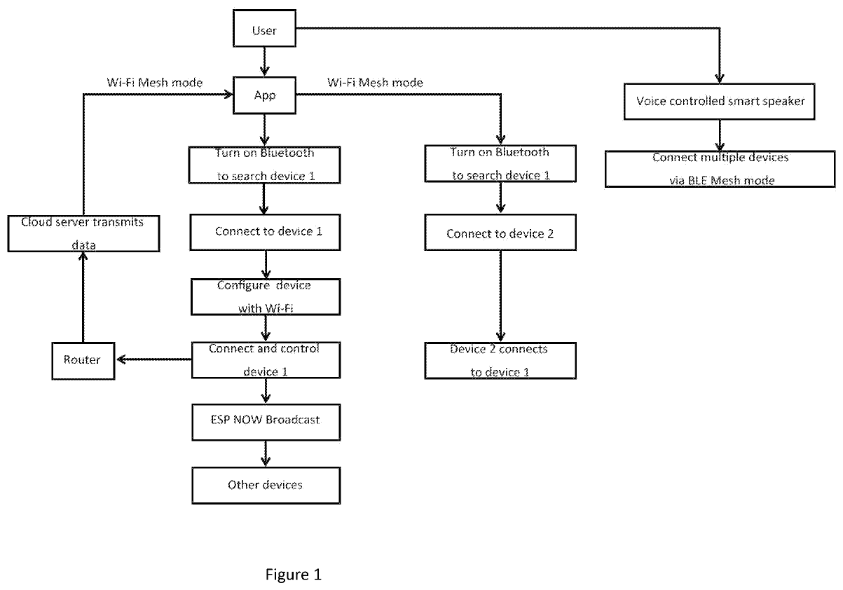

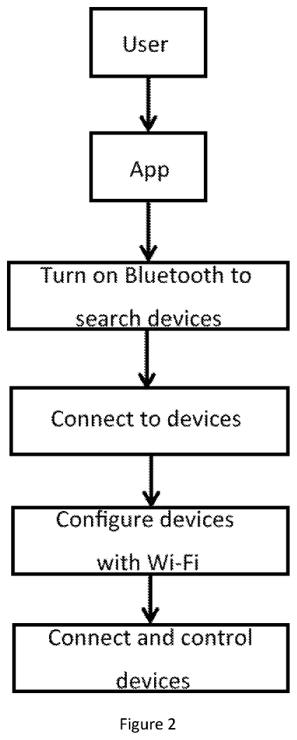

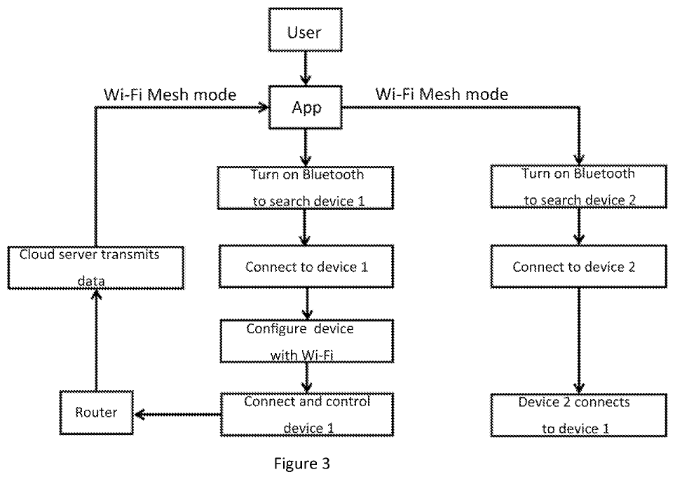

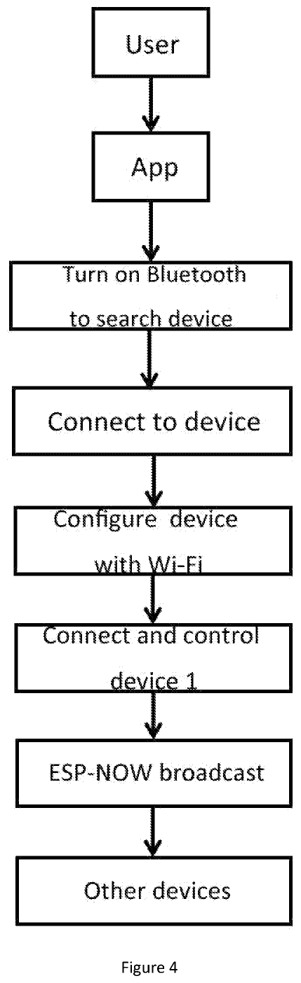

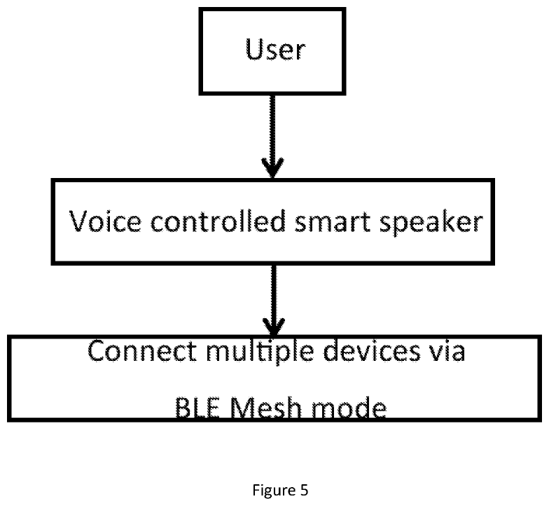

Please refer to FIGS. 1-5, the present invention provides a multi-protocol combined IoT networking method, comprising:
a lighting module, an MCU control module, and a server module, wherein the lighting module comprises various smart light devices, the MCU control module is used to achieve integration of multiple protocols for IoT networking, and the server module is used to enable communication between a mobile terminal app and the lighting module, as well as to store status information of the lighting module; and the multi-protocol combined IoT networking method further comprises following steps:
S1: a user employs a mobile terminal app to initiate Bluetooth and perform device search within the lighting module through a Wi-Fi Mesh mode;
S2: upon successful discovery, connection with devices is established;
S3: when a single device needs to be controlled, the single device is configured with Wi-Fi and then connected for control;
S4: when multiple devices need to be controlled, multiple devices are searched and connected at a same time in S1, and multiple devices are connected through the Wi-Fi Mesh mode; and
S5: one of the multiple devices transmits data to the server module through a router, and the data information is fed back to the mobile terminal app via Wi-Fi Mesh.

Further, connection with other devices is also able to be established through the ESP-NOW mode after connection with the devices is established.

Further, the devices are able to be connected to each other in a BLE-Mesh mode through voice control by the user.

The present invention has following working principles:

If a customer chooses Wi-Fi Mesh control, initially, a mobile app is used to configure network for a device via Bluetooth communication, after successful configuration, the device forms a group by itself and all devices in the group can be controlled through the mobile app, or individual devices within the group can be controlled separately, and the devices can also be controlled between each other via ESP-NOW. For voice control, a smart voice speaker is used to form a group by using BLE-Mesh, so as to control all devices within the group through voice commands.

BLE, namely Bluetooth Low Energy refers to Bluetooth low power consumption.

BLE-Mesh, namely Bluetooth Mesh, is a mesh networking standard based on Bluetooth Low Energy, allowing for multi-to-multi communication via Bluetooth radio.

Wi-Fi Mesh refers to a network technology based on multi-hop routing and peer-to-peer networks and represents a new network structure.

ESP-NOW refers to a wireless communication protocol that allows multiple devices to communicate without or in situations where Wi-Fi is not available.

The above are only preferred embodiments of the present invention, and are only used to help understand the method and its core idea of the present invention. The protection scope of the present invention is not limited to the above-mentioned embodiments. All technical solutions falling under the idea of the present invention belong to the protection scope of the present invention. It should be pointed out that for those of ordinary skill in the art, several improvements and modifications may be made without departing from the principles of the present invention, and these improvements and modifications should also be regarded as the protection scope of the present invention.

In the description of the present invention, it should be noted that the orientation or positional relationship indicated by the terms “upper”, “lower”, “inner”, “outer”, etc. are based on the orientation or positional relationship shown in the drawings, which are only for the convenience of describing the present invention and simplifying the description, but do not indicate or imply that devices or elements referred to must have specific orientations, be constructed and operated in specific orientations, and therefore cannot be construed as a limitation of the present invention.

The present invention holistically addresses issues in the prior art that the control of multiple ordinary lighting equipment relies on multiple multi-link switches at different positions to achieve diversified switches, brightness and other scene selections, high wiring demands and high elevated hardware costs. In the present invention, an MCU control module is used to integrate multiple protocols, so as to realize the control of single or multiple smart lights only through a mobile phone APP, and the networking method is reasonable and does not require additional communication lines. Furthermore, the present enables control through voice commands, thus meeting diverse user selection requirements.

1. A multi-protocol combined IoT networking method, comprising a lighting module, an MCU control module, and a server module, wherein the lighting module comprises various smart light devices, the MCU control module is used to achieve integration of multiple protocols for IoT networking, and the server module is used to enable communication between a mobile terminal app and the lighting module, as well as to store status information of the lighting module; and the multi-protocol combined IoT networking method further comprises following steps:
S1: a user employs a mobile terminal app to initiate Bluetooth and performs device search within the lighting module through a Wi-Fi Mesh mode;
S2: upon successful discovery, connection with devices is established;
S3: when a single device needs to be controlled, the single device is configured with Wi-Fi and then connected for control;
S4: when multiple devices need to be controlled, multiple devices are searched and connected at a same time in S1, and multiple devices are connected through the Wi-Fi Mesh mode; and
S5: one of the multiple devices transmits data to the server module through a router, and the data information is fed back to the mobile terminal app via Wi-Fi Mesh.

2. The multi-protocol combined IoT networking method according to claim 1, wherein connection with other devices is also able to be established through the ESP-NOW mode after connection with the devices is established.

3. The multi-protocol combined IoT networking method according to claim 1, wherein the devices are able to be connected to each other in a BLE-Mesh mode through voice control by the user.
